(19) United States
(12) Patent Application Publication
(10) Pub. No.: US 2018/0188999 A1
(43) Pub. Date: Jul. 5, 2018

(54) INTEGRATED CIRCUIT INPUTS AND OUTPUTS

(71) Applicant: Nordic Semiconductor ASA, Trondheim (NO)

(72) Inventors: Joar Olai RUSTEN, Trondheim (NO); Rolf AMBÜHL, Trondheim (NO)

(73) Assignee: Nordic Semiconductor ASA, Trondheim (NO)

(21) Appl. No.: 15/736,761

(22) PCT Filed: Jun. 16, 2016
(86) PCT No.: PCT/GB2016/051798

§ 371 Date: Dec. 14, 2017

(30) Foreign Application Priority Data
Jun. 16, 2015 (GB) 1510607.3

(51) Int. Cl. G06F 3/06; G06F 13/16; G06F 13/40

(52) U.S. Cl. CPC G06F 3/0659; G06F 3/0611; G06F 13/4068; G06F 13/16; G06F 3/0679

(57) ABSTRACT

An integrated circuit microprocessor device comprises a central processing unit (CPU) and a general purpose input or output module (2) having a plurality of external connections (4). The external connections are configured by the general purpose input or output module to provide respective inputs to the device. The device further comprises respective memory locations (6) corresponding to each of the external connections. The memory locations are arranged to record a change of state on one or more of the external connections in the event that the change of state occurs while the central processing unit is in a low power state or otherwise unable to react to the change of state.

This invention relates to inputs and outputs for integrated circuits—particularly general purpose input/output pins for a microprocessor or System on Chip (SoC) device.

With the increasing complexity of modern microprocessors and SoC's, there is an increasing demand to provide inputs and outputs associated with the various functions. However these require pins projecting from the external casing of the device and so the number which can be provided is limited by the constraints on physical size posed by the somewhat conflicting demand for ever-increasing miniaturisation.

One approach for addressing this tension is to provide a number of general purpose input/output (GPIO) pins whose function can be allocated dynamically in software by tasks which are running. This allows efficient use of pins rather than having a lot of dedicated pins which may not be used very much, or at all in some applications or by some customers.

When GPIO pins are configured to receive inputs from off-chip components it will often be the case that such inputs are of the sort which prompt the CPU to wake from a low power, dormant state in order to process them. They could for example come from computer input devices such as a wireless keyboard, mouse or the like. The Applicant has now, however, recognised a potential problem that could arise where there are multiple such inputs, in that during the finite time it takes for the CPU to power up from its dormant state, the input which prompted the CPU to wakeup may no longer be present and it is not therefore possible for the CPU to determine how to respond.

The present invention aims to address this and provides an integrated circuit microprocessor device comprising a central processing unit and a general purpose input or output module having a plurality of external connections, the external connections being configured by the general purpose input or output module to provide respective inputs to the device, the device further comprising respective memory locations corresponding to each of said external connections and being arranged to record a change of state on one or more of said external connections in the event that said change of state occurs while said central processing unit is in a low power state or otherwise unable to react to said change of state.

Thus it will be seen by those skilled in the art that in accordance with the invention if there is a change of state on an external connection—i.e. going from low to high or vice versa—while the CPU is asleep, or otherwise unable to react—e.g. because it is going to sleep or still waking from sleep—this is recorded in memory. This allows the CPU to determine which inputs were received even if the input is no longer present once it has woken up. It also allows inputs to be captured that occur at other times when they cannot be processed by the CPU e.g. when a “sleep” signal has been issued and the input is received too late to abort the process of shutting down the CPU.

In a set of embodiments the change of state is arranged to wake up the central processing unit (CPU)—i.e. cause the CPU to move from a low power state to a higher power state. This could be the case for all external connections. However this is not essential and in a set of embodiments a change of state of one or more of the external connections does not wake the CPU. This may be advantageous in saving power by allowing certain inputs to be configured so as not to wake the CPU immediately but advantageously the change of state is recorded in the corresponding memory location so that it can be read by the CPU when it does wake. In a set of embodiments the device comprises an enabling register arranged to determine which of said external connections is able to wake the CPU when it changes state. This could, for example, comprise a plurality of flags associated with the memory locations.

Advantageously the CPU is arranged to read said memory locations once it has woken up (moved to said higher power state). In a set of embodiments the CPU is configured to clear one of said memory locations if it reads a value indicating said change of state. In a further set of such embodiments the general purpose input or output module is configured to generate an event if a further one of said memory locations contains a value indicating said change of state on a further external connection. This may help to ensure that no incoming signals on the external connections are lost due to race conditions. This ability to distinguish between multiple inputs which are received simultaneously or at least all before the CPU wakes up is an important advantage.

In a set of embodiments the memory locations are provided by a register having one or more bits (preferably one) corresponding to each of said external connections.

Certain embodiments of the invention will now be described, by way of example only, with reference to the accompanying drawings in which:

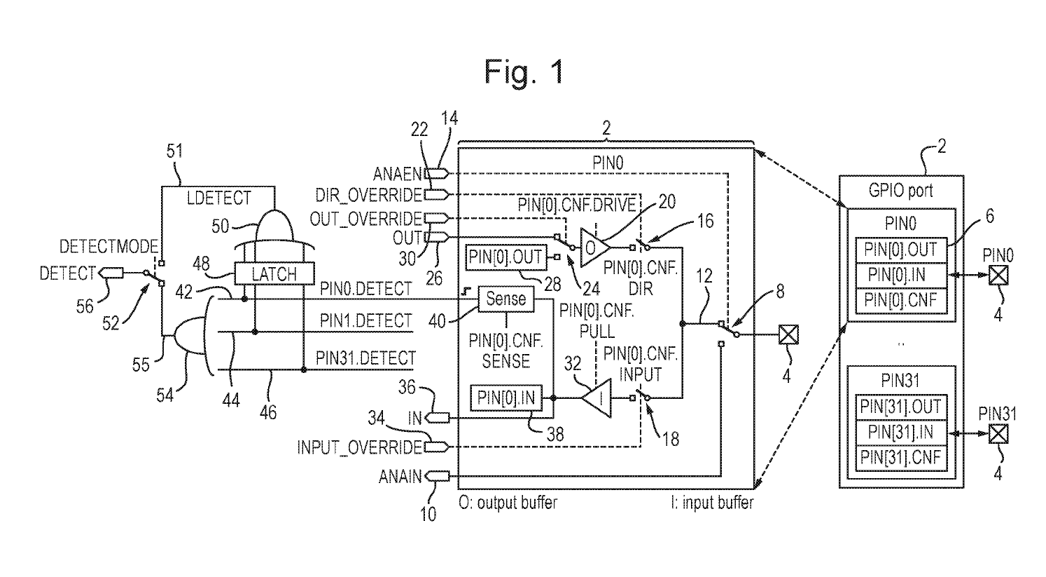

FIG. 1 is a schematic representation if a GPIO module in accordance with the invention;

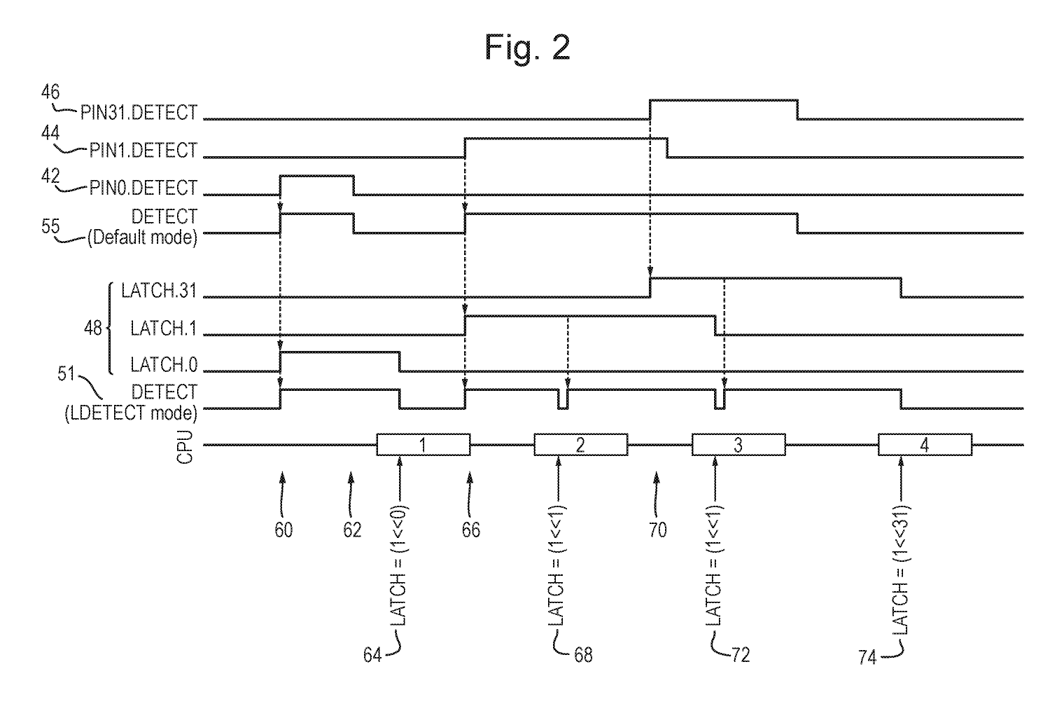

FIG. 2 is a timing diagram illustrating operation of the module; and

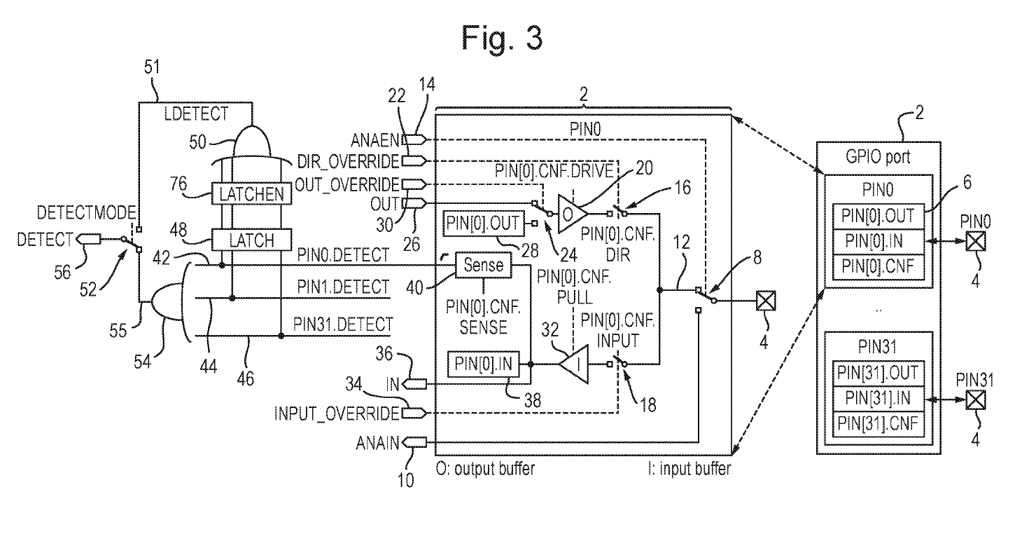

FIG. 3 is a schematic representation of a further embodiment of the invention.

FIG. 1 illustrates a GPIO module 2 which is included as part of an integrated circuit microprocessor. The GPIO module 2 supports thirty two external connections in the form of pins 4 numbered PIN0 to PIN31, only the first and last of which are shown in FIG. 1. Each pin 4 has an associated channel 6 in the GPIO module which includes three registers labelled PIN[n].OUT, PIN[n].IN and PIN[n].CNF.

The channel 6 corresponding to PIN0 is represented in greater detail in the left hand portion of FIG. 1. This shows that the pin 4 is connected to a switch 8 which allows the pin 4 to be selectively connected to an analogue input line 10 for providing an analogue input to elsewhere on the microprocessor. Alternatively the switch 8 may connect the pin 4 to a connection 12 for a digital input/output arrangement, described in more detail below. The switch is controlled by an ‘analogue enable’ control line 14 which is made to go high when the microprocessor expects to receive analogue inputs.

The digital input/output arrangement connection 12 is connected to two switches 16, 18. The first of these switches 16 allows the pin 4 to be connected to an output buffer 20. The switch 16 is controlled by a ‘direction override’ line 22. The input to the output buffer 20 is controlled by a further switch 24 which allows the buffer 20 to be connected either to an output line 26 for providing an ordinary output from a particular module in the microprocessor or to the PIN[0].OUT register 28. This register 28 is written with a value determined by SET and CLR tasks from a further module (not shown) known as the general purpose input/output tasks and events (GPIOTE) module which converts outputs into tasks and inputs into events. The switch 24 is controlled by an ‘output override’ line 30 which therefore allows the pin 4 to be forced to the value in the PIN[0].OUT register 28.

On the digital input side, the switch 18 selectively connects the pin 4 to the input buffer 32 under the control of an ‘input override’ line 34. This allows a peripheral that takes over control of the GPIO pin to use it as an output to disconnect the input buffer 32 which is beneficial as the input buffer typically consumes energy even if not being used. The input buffer 32 is connected to an input line, the PIN[0].IN register 38 which is used by the CPU to find out the state of the pin 4 and a sensing module 40 which senses when the input goes high and then generates a PIN0.DETECT signal 42. The sensing module 40 could also be configured to generate the signal 42 when the input goes low instead.

Corresponding arrangements are provided for the other pins PIN1-PIN31. These are not shown in detail but each has a corresponding PINn.DETECT signal. The PIN1.DETECT and PIN31.DETECT signals 44, 46 are shown with intermediate ones omitted.

The PINn.DETECT signals 42, 44, 46 are copied into a latch register 48 which has thirty-two bits corresponding to each of the PINn.DETECT lines 42, 44, 46 etc. An OR function 50 gives a latched DETECT (LDETECT) signal 51 which is high if a one is recorded for any of the bits in the latch register 48. This is fed to one side of a DETECT ouput switch 52. The other side of the switch 52 is connected to another OR function 54 which provides a conventional common DETECT signal 55 directly from the PINn.DETECT lines 42, 44, 46 etc.

In use the module 2 acts like a conventional general purpose input/output module. The pin 4 can therefore be used to receive an analogue input by setting the analogue enable line 14 high. It can also be used as a digital output pin by setting the analogue enable line 14 low, the input override line 35 low to open the switch 18 and setting the direction override line 22 high to close the switch 16. Although in most cases it will be desirable to have one of the switches 16, 18 open while the other is closed, there may be circumstances where both are closed.

When used as a digital output, the pin 4 normally provides output from the output line 26. However if it is required to SET the pin 4 by driving it high or CLR the pin 4 by driving it low, the output override line 30 is made high which connects the output buffer 20 to the PIN[0].OUT register 28 to drive it to whatever value is stored there.

The pin 4 can further be used as a digital input pin by setting the analogue enable line 14 low, the input override line 35 high to close the switch 18 and setting the direction override line 22 low to open the switch 16.

The pins 4 may be used to connect, for example, to buttons on an external peripheral. In order to conserve power it will be desirable to have the central processing unit (CPU) (not shown) in a low power, sleep state until a user presses one of the buttons. When they do press a button however, e.g. that connected to PIN0, an interrupt is sent to the CPU to wake it up so that it can respond to the input as will now be explained.

As the voltage level on the pin 4 goes high, this is passed through the input buffer 32 to the input line 36 and to the sensing module 40. The sensing module 40 detects the transition from low to high and so its output 42 goes high which triggers the conventional OR function 54 and is copied into the appropriate bit of the latch register 48 as a one (which normally has all its bits at zero). This in turn triggers the latch OR function 50. Thus whichever position the switch 52 is in, the DETECT signal output 56 goes high which causes an interrupt in a power module (not shown) which wakes up the CPU. It will be appreciated however that in practice it takes some time for the CPU to wake up and be fully active. In that time if the button is released and the pin 4 goes low, the input line 36 corresponding to it will also go low and the CPU will not be able to determine from the input lines 36 (and those corresponding to other pins) what triggered the wake up.

However in the embodiment of the invention shown in FIG. 1, the input which triggered the wake up can simply be read by the CPU from the latch register 48 since the bits of this register can only be cleared explicitly by the CPU. Thus even if the input is only momentary, it will be captured rather than being lost. A similar advantage is obtained if an input is received while the CPU is entering a dormant state too late to abort the sleep procedure.

The switch 52 allows the DETECT output 56 so be selected as either a conventional common DETECT signal 55 or the LDETECT signal 51 depending on the requirements of the particular application. However in either mode the latch register 48 can be read to determine what inputs were received.

Once the CPU has read a one on a given bit of the latch register 48, it clears that bit. One advantage of the LDETECT signal 51 is that if there are other bits of the regsiter 48 set to one, the LDETECT signal will remain high, although a transitory negative pulse in the LDETECT signal 51, long enough to trigger a new event, is generated. This allows the CPU to distinguish between multiple inputs received while it is asleep or starting to wake up. Once all bits have been successfully cleared, the LDETECT signal 55 will go low again.

FIG. 2 illustrates the difference in operation of the conventional common DETECT signal 55 and the LDETECT signal 51 when individual PINn.DETECT signals 42, 44, 46 go high, potentially simultaneously,

First, at time 60, PIN0 goes high (e.g. because a button is pressed) and so the PIN0.DETECT line 42 goes high. This causes the common DETECT signal 55 to go high as well as the bit corresponding to PIN0 (“LATCH.0”) in the latch register 48. This in turn causes the LDETECT signal 51 to go high as well.

At time 62 the button connected to PIN0 is released and so the PIN0.DETECT line 42 goes low and because none of the other PINn.DETECT lines is high, the common DETECT signal 55 also goes low again. However, since the LATCH.0 signal remains high, so does the LDETECT signal 51. In fact these remain high until time 64 when the CPU has woken up and reads the LATCH 0.0 signal from the latch register 48 and so clears it. It will be appreciated from this that the common DETECT signal 55 has already gone low before the CPU wakes up and therefore were it not for the latch register 48, the CPU would not be able to determine which of the pins had woken it up.

At a later time 66, the PIN1.DETECT signal 44 goes high and so does the DETECT signal 55, the LATCH.1 bit of the latch register 48 and the LDETECT signal 51. When the CPU reads the latch register 48 at time 68, a negative pulse is generated in the LDETECT signal 51 but it remains high thereafter since the PIN1.DETECT line 44 is still high at this point in time.

At time 70, the button connected to PIN31 is also pressed so that the PIN31.DETECT line 46 goes high. The common DETECT signal 55 is already high and therefore remains so, although the LATCH.31 bit of the latch register 48 now goes high. At time 72, the CPU reads the latch register 48 again and clears the LATCH.1 bit since the PIN1.DETECT line 44 has, by this time, gone low again. However the LDETECT signal 51 remains high, with a negative pulse, because the LATCH.31 bit is still high. Finally, at time 74, the PIN31.DETECT signal 46 has gone low and so when the CPU reads the LATCH.31 bit of the latch register 48, the LATCH.31 bit is cleared and the LDETECT signal 51 is also put low again.

FIG. 3 shows a second embodiment which is very similar to the embodiment shown in FIG. 1 and the same reference numerals have been used to denote the same features. The embodiment of FIG. 3 however comprises an additional ‘latch enable’ register 74 between the latch register 38 and the OR gate 50 which generates the LDETECT signal 51. The latch enable register 74 also comprises one bit per pin 4. and in use decides which of the LATCH bits (and therefore in effect which of the pins' transitions) will be routed to the OR gate 50. Only those Itach bits which are routed to the OR gate 50 will trigger the LDETECT signal 51 and so wake up the CPU. This allows the GPIO module 2 to record transitions on some or all pins 4, but only to wake-up the CPU from some of them, one of them, or none. This may be useful in situations where it is important to record the transition but where it is not important, or even desirable, to wake up the system at the time when the transition happens. In such a setup it may be more desirable to process and respond to the transition when the CPU wakes up for some other reason.

The latch enable register 74 may of course be configurable to change which pins 4 can wake the CPU.

Thus it will be seen that the embodiments described above allows inputs to be recorded until a CPU is fully awake and able to process them without losing any information. It will be appreciated however that the particular embodiment is merely exemplary and that many modifications and variations could be made within the scope of the invention.

1. An integrated circuit microprocessor device comprising a central processing unit (CPU) and a general purpose input or output module having a plurality of external connections, the external connections being configured by the general purpose input or output module to provide respective inputs to the device, the device further comprising respective memory locations corresponding to each of said external connections and being arranged to record a change of state on one or more of said external connections in the event that said change of state occurs while said central processing unit is in a low power state or otherwise unable to react to said change of state.

2. The device as claimed in claim 1, wherein the change of state is arranged to wake up the CPU.

3. The device as claimed in claim 1, wherein a change of state of one or more of the external connections does not wake the CPU.

4. The device as claimed in claim 3, comprising an enabling register arranged to determine which of said external connections is able to wake the CPU when it changes state.

5. The device as claimed in claim 4, wherein the enabling register comprises a plurality of flags associated with the memory locations.

6. The device as claimed in claim 1, wherein the CPU is arranged to read said memory locations once it has moved to a higher power state.

7. The device as claimed in claim 6, wherein the CPU is configured to clear one of said memory locations if it reads a value indicating said change of state.

8. The device as claimed in claim 7, wherein the general purpose input or output module is configured to generate an event if a further one of said memory locations contains a value indicating said change of state on a further external connection.

9. The device as claimed in claim 1 wherein the memory locations are provided by a register having one or more bits corresponding to each of said external connections.
